(19) United States
(12) Patent Application Publication
(10) Pub. No.: US 2026/0264881 A1
(43) Pub. Date: Sep. 10, 2026

(54) SYSTEMS AND METHODS FOR SUPPLEMENTING AIRCRAFT CHECK USING COMPUTER VISION, ANALYTICS, AND AUGMENTED REALITY

(71) Applicant: ARINC Incorporated, Annapolis, MD (US)

(72) Inventors: Ajay Kumar, Bangalore (IN); David F. Larsen, Lynchburg, TN (US); Ashutosh Kumar Jha, Bangalore (IN); Banavara Anantharam Srinivas Prasad, Bangalore (IN); Tanoy Bhattacharjee, Bangalore (IN)

(21) Appl. No.: 19/014,868

(22) Filed: Jan. 9, 2025

(30) Foreign Application Priority Data
Feb. 2, 2024 (IN) 202411007175

(51) Int. Cl. B64F 5/60; G01J 5/00; G01J 5/08; G06F 3/14; G06T 7/00; G06T 11/00; G07C 5/00; G10L 15/02; G10L 15/06; G10L 15/08; G10L 15/22; H04N 13/204; H04N 23/11; H04N 23/13; H04N 23/56

(52) U.S. Cl. CPC B64F 5/60; G01J 5/0859; G06F 3/1423; G06T 7/0002; G06T 11/00; G07C 5/008; G10L 15/02; G10L 15/063; G10L 15/08; G10L 15/22; H04N 13/204; H04N 23/11; H04N 23/13; H04N 23/56; G01J 2005/0077; G06T 2207/10012; G06T 2207/10048; G06T 2207/20081; G06T 2207/30248; G10L 2015/223

(57) ABSTRACT

An Aircraft Visual Inspection Assist System (AVIAS) is disclosed. The system includes a first display, at least one sensor configured to sense an aspect of an aircraft component, wherein sensing an aspect of the aircraft component generates AVAIS output data, and at least one processor communicatively coupled to the first display and the at least one sensor. The at least one processor configured to obtain AVIAS output data, the AVIAS output data including a current description of the aircraft component, obtain a trained artificial intelligence (AI) and/or machine learning (ML) model, based at least on the AVIAS output data and the trained AI and/or ML model, infer a damage state of the aircraft component, and display information regarding the damage state of the aircraft component on the first display.

### CROSS-REFERENCE TO RELATED APPLICATION

The present application claims the benefit of India Provisional Application No. 202411007175, filed Feb. 2, 2024, which is incorporated herein by reference in the entirety.

### BACKGROUND

Aircraft visual inspections are the fastest method of assessing the overall condition of an aircraft and its components. Over 80% of inspections on large transport aircraft are visual. As the most recurrent procedure in airport or maintenance, repair, and overhaul (MRO), inspections can range from a casual walk around to a detailed visual inspection including utilizing a preflight or postflight checklist. These are time-consuming, error-prone, and human judgment-centric. The provision to store the inspection evidence is also manual and time-consuming. Therefore, there is a need for a system and method for performing aircraft visual inspections more efficiently.

### SUMMARY

In some aspects, the techniques described herein relate to a system including: a first display; at least one sensor configured to sense an aspect of an aircraft component, wherein sensing an aspect of the aircraft component generates Aircraft Visual Inspection Assist System (AVIAS) output data; and at least one processor first communicatively coupled to the first display and the at least one sensor, the at least one processor configured to: obtain AVIAS output data, the AVIAS output data including a current description of the aircraft component; obtain a trained artificial intelligence (AI) and/or machine learning (ML) model; based at least on the AVIAS output data and the trained AI and/or ML model, infer a damage state of the aircraft component; and display information regarding the damage state of the aircraft component on the first display.

In some aspects, the techniques described herein relate to a system, further including a microphone communicatively coupled to the at least one processor and configured to detect a voice of an operator, the at least one processor further configured to; acquire speech data from the microphone; extract features from the speech data; classify extracted features of the speech data to create classified extracted features; and generate a command based on the classified extracted features, wherein the command includes an operation of a function of the first display or the at least one sensor.

In some aspects, the techniques described herein relate to a system, wherein the first display is a head- or body-worn display.

In some aspects, the techniques described herein relate to a system, further including an edge device communicatively coupled to the at least one processor, the edge device including a second display.

In some aspects, the techniques described herein relate to a system, further including: a server including at least one of the at least one processor and configured to communicate with the first display and the at least one sensor via a wired or wireless interface.

In some aspects, the techniques described herein relate to a system, further including at least one illumination source configured to illuminate the aircraft component.

In some aspects, the techniques described herein relate to a system, wherein the at least one illumination source includes an ultraviolet light source.

In some aspects, the techniques described herein relate to a system, wherein the head-worn display further includes a microphone and an illumination source.

In some aspects, the techniques described herein relate to a system, wherein one of the at least one sensor includes a three-dimensional (3D) camera configured to record 3D information about the aircraft component.

In some aspects, the techniques described herein relate to a system, wherein one of the at least one sensor includes a thermal camera.

In some aspects, the techniques described herein relate to a system, wherein one of the at least one sensor includes an ultrasonic sensor.

In some aspects, the techniques described herein relate to a system, wherein the damage state includes corrosion.

In some aspects, the techniques described herein relate to a system, wherein the damage state includes fluid leakage.

In some aspects, the techniques described herein relate to a system, wherein the trained AI and/or ML model is trained using a supervised learning model.

In some aspects, the techniques described herein relate to a system, wherein the trained AI and/or ML model is trained using a transfer learning technique.

In some aspects, the techniques described herein relate to a system, wherein the system further includes a speech-based AI and/or ML model that has been trained using a supervised technique.

In some aspects, the techniques described herein relate to a system, wherein the system further includes a speech-based AI and/or ML model that has been trained using an unsupervised technique.

In some aspects, the techniques described herein relate to a system, wherein the system further includes a speech-based AI and/or ML model that has been trained using a transfer learning technique.

In some aspects, the techniques described herein relate to a system, wherein the system further includes a speech-based AI and/or ML model that has been trained using a transformer model technique.

In some aspects, the techniques described herein relate to a method including: speaking an instruction for operating a sensor via a microphone; operating the sensor and recording sensor data of an aircraft component based on the instruction, generating AVIAS output data; transmitting the AVIAS output data to a server; analyzing the AVIAS output data via a trained artificial intelligence (AI) and/or machine learning (ML) model; inferring a damage state of the aircraft component based on an analysis of the AVIAS output data; displaying information regarding the damage state of the aircraft component on a first display; and recording a voice-based log based on displayed information regarding the damage state of the aircraft component via the microphone.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a block diagram of the processing componentry of a system, in accordance with one or more embodiments of the disclosure.

FIG. 2 illustrates a block diagram of a processing system, the aircraft components analyzed by the processing system, and an output of the processing system, in accordance with one or more embodiments of the disclosure.

FIG. 3 illustrates a block diagram of a system for assisting in a check of aircraft, in accordance with one or more embodiments of the disclosure.

FIG. 4 is a block diagram for processing speech, in accordance with one or more embodiments of the disclosure.

FIG. 5 illustrates spotting points of an aircraft used for performing a check, in accordance with one or more embodiments of the disclosure.

FIG. 6 illustrates a high-level setup of a system for checking an aircraft, in accordance with one or more embodiments of the disclosure.

FIG. 7 illustrates a high-level setup of a microphone and speech processing module, in accordance with one or more embodiments of the disclosure.

FIG. 8 illustrates a sample of an augmented reality-based view by the system, in accordance with one or more embodiments of the disclosure.

FIG. 9 illustrates a sample of thermal imaging-based inspection of aircraft tires and other components, in accordance with one or more embodiments of the disclosure.

FIG. 10A and FIG. 10B illustrate a system assisting in overlaying an image of the surface under inspection over predefined augmented reality-based surfaces and applying algorithms to detect any edge, surface, or missing part defects, in accordance with one or more embodiments of the disclosure.

FIG. 11 illustrates an augmented view of a non-corroded and corroded surface, in accordance with one or more embodiments of the disclosure.

FIG. 12 illustrates different types of corrosion detected by the system, in accordance with one or more embodiments of the disclosure.

FIG. 13 illustrates a damaged coating detected by the system, in accordance with one or more embodiments of the disclosure.

FIG. 14 illustrates examples of damaged coating, in accordance with one or more embodiments of the disclosure.

FIG. 15 illustrates a detection of a leak using normal and ultraviolet light, in accordance with one or more embodiments of the disclosure.

FIG. 16 illustrates a flow diagram of a method for training a machine learning model to detect corrosion, in accordance with one or more embodiments of the disclosure.

FIG. 17 illustrates a flow diagram of a method for training a machine learning model to detect dents, in accordance with one or more embodiments of the disclosure.

FIG. 18 illustrates a flow diagram of a method for training a machine learning model to detect damaged coatings, in accordance with one or more embodiments of the disclosure.

FIG. 19 illustrates a flow diagram of a method for real-time inspection of an exterior of an aircraft body, in accordance with one or more embodiments of the disclosure.

FIG. 20 illustrates a flow diagram of a workflow for analyzing AVIAS output data, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein may be directed to a method and system including an Aircraft Visual Inspection Assist System (AVIAS) configured to use an artificial intelligence (AI) and/or machine learning (ML) model to assess a damage state of an aircraft component in an aircraft. The method and system may include at least one camera or sensor for recording imagery/data of the aircraft component and at least one display that enables an operator to utilize the system and method. In some embodiments, the system and/or method may include an AI AND/OR ML-enabled microphone (e.g., using a speech-based AI or ML model) that enables the operator to speak instructional commands for components of the system, such as the at least one camera.

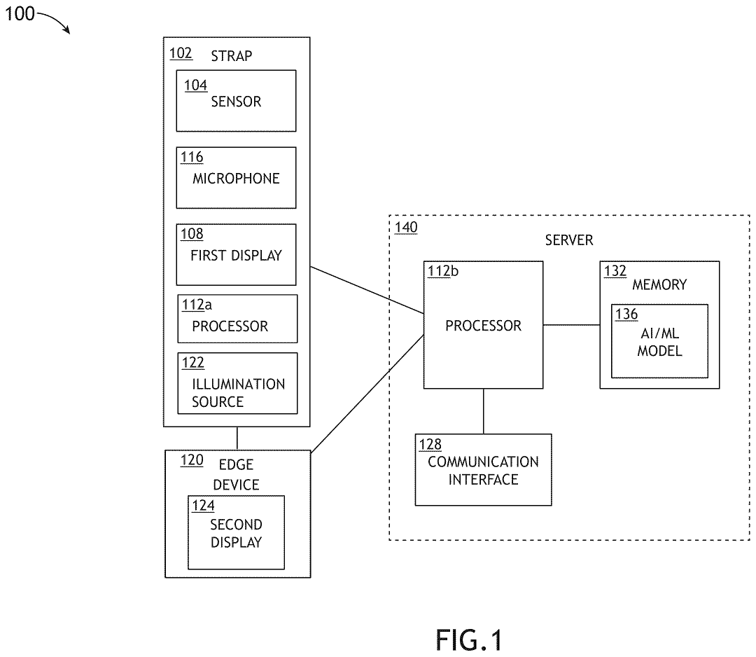

Referring to FIGS. 1-20, embodiments of a system 100 (e.g., an Aircraft Visual Inspection Assist System (AVIAS)) according to the inventive concepts disclosed herein are depicted. In some embodiments, the system 100 includes a strap (e.g., for a head worn or body worn device). The strap includes a sensor 104 (e.g., a camera or other sensing device), a first display 108, and at least one processor 112a communicatively coupled to the sensor 104 and the first display 108. In some embodiments, the system 100 further includes a microphone 116 communicatively coupled to the at least one processor 112a. In some embodiments, the system further includes an edge device 120 (e.g., personal digital assistant (PDA)) that includes a second display 124 communicatively coupled to the strap 102. In some embodiments, the system 100 further includes at least one illumination source 122 configured to illuminate the system component. The system 100 further includes a communication interface 128 and a memory 132 communicatively coupled to the one or more processors 112b. The memory 132 stores instructions and data for the one or more processors 112b including model data related to artificial intelligence (AI) training and machine learning (ML) training (e.g., AI AND/OR ML models 136). The model 136 may be accessed remotely (e.g., wired or wirelessly via server 140), or may be included within the one or more processers 112a and memory of the strap components (e.g., the sensor 104, microphone 116, or first display 108). In this manner, the data processing performed by the system 100 may performed in the entirely (1) by the strap components within the strap 102, (2) by the strap components and the server 140, (3) by the strap components and the edge device, or (4) by the strap components, the server 140, and the edge device.

The sensor 104 may include any type of sensing device including but not limited to an optical sensor (e.g., a camera), a radar-based sensor, a lidar-based sensor, a sonar-based sensor, an ultrasonic sensor, or a thermal-based sensor. For example, the sensor 104 may include a 2D camera configured to capture images in two dimensions. In another example, the sensor 104 may include a 3D camera configured to capture three-dimensional data about objects or scenes. In another example, the sensor 104 may include a thermal camera, such as an infrared camera or thermal imaging camera. The system 100 may include any number of sensors 104 and any number of types of sensors 104. For example, the system 100 may include a set of sensors 104 that include a 2D camera, a 3D camera, and a thermal camera.

In embodiments, the first display 108 is configured as a head-worn display (HWD) or body worn display that allows an operator to see both real-world objects and text and/or images that are displayed on the first display 108 (e.g., an augmented reality display). For example, the system 100 may include one or more sensors 104 and a first display that is fixed to a strap or spectacle frame that is wearable on the head or helmet of an operator. The one or more sensors 104 record data sensed in the general gaze of the operator and can display data based on the recorded data (e.g., a damage state on an aircraft component) on the first display 108.

In embodiments, the microphone 116 is configured to capture voice data (e.g., voice commands from the operator), and the system 100 is configured to perform actions based on the captured voice data. For example, the microphone may be configured to perform action based on voice commands that include instructing the sensor 104 to collect and/or record data and instructing the sensor 104 to zoom in or zoom out when collecting data. The system 100 may include one or more of the one or more processors 112a-b to specifically perform one or more of the steps acquired for instructing the one or more sensors 104 based on the speech of the operator. For example, the one or more of the one or more processors may include a speech data acquisition system that applies a trained speech model to determine a command for the sensor 104 to perform an action based on a spoken instruction. The microphone 116 may also be configured to record voice-based logs from the operator that are then saved within the system 100. The microphone 116 may also be configured to pick up aircraft-related noise, such as engine noise, which may then be used for diagnostic purposes.

In embodiments, the edge device 120 may include any type of handheld device that allows an operator to view and interact with data from the sensors 104 (e.g., AVIAS output data), and damage state data (e.g., AVIAS data that has been analyzed by the one or more processors 112a-b to generate or infer a damage state of the aircraft component). The edge device 120 may include, but not be limited to, a handheld device, a mobile phone, a PDA, a tablet computer, or other mobile computing device. The edge device 120 may be configured to receive data from either the sensor 104, the microphone 116 (e.g., pre-processed data), or data analyzed by the one or more processors 112a-b (e.g., post-processed data). The edge device 120 may be configured to receive image data (e.g., on the second display 124) that the operator can use to view, and manipulate the view of, pre-processed and/or post-processed image data.

The illumination source 122 may include any type of illuminating light including, but not limited to, a light-emitting diode (LED). The illumination source 122 may be configured to emit light in the visible spectrum to assist the operator and/or sensor 104 in visualizing the aircraft component 200. In some instances, the illumination source 122 is configured to emit light in a non-visible spectrum, such as ultraviolet light, for the detection of leaks 236, such as oil leaks.

The processing componentry of the system 100 may be implemented as any suitable computing device and may include any or all of the elements as shown in FIG. 1, with some or all elements being communicatively coupled at any one time. For example, the at least one processor 112a-b may include at least one central processing unit (CPU), at least one graphics processing unit (GPU), at least one field-programmable gate array (FPGA), at least one application-specific integrated circuit (ASIC), at least one digital signal processor (DSP), at least one deep learning processor unit (DPU), at least one virtual machine (VM) running on at least one processor, and/or the like configured to perform (e.g., collectively perform) any of the operations disclosed throughout. For example, the at least one processor 112a-b may include a CPU and a GPU configured to perform (e.g., collectively perform) any of the operations disclosed throughout.

The processor 112a-b may be configured to run various software applications or computer code stored (e.g., maintained) in a non-transitory computer-readable medium (e.g., memory 132 and/or storage) and configured to execute various instructions or operations. For example, the at least one processor 112a-b of the system 100 may be configured to: accept commands (e.g., voiced commands), receive data from the sensor 104 (e.g., such as AVIAS output data), receive data from the microphone 116, analyze data, such as AVIAS output data, via a trained artificial intelligence (AI) and/or machine learning (ML) model (e.g., as stored in memory 132), generate and/or infer a damage state of the aircraft component based on an analysis of the AVIAS output data, and display information regarding the damage state of the aircraft component on the first display 108 and/or second display 124. One or more processors 112 of the at least one processor 112 may be incorporated into one or more components of the system (e.g., the sensor 104, the first display 108, the edge device 120, the microphone 116).

In some embodiments, one or more of the at least one processor 112b is positioned remotely from the sensor 104, the first display 108, the edge device 120, the microphone 116. For example, the one or more of the at least one processor 112b may be included in a server 140 operating remotely from one or more components of the system. The server 140 may provide all of the processing power of the system 100 or a portion of the processing power of the system 100. For example, the system 100 may include a distributed system that enables partial processing of data on the edge device 120 or other system components, as well as partial processing of data on the server 140.

The communication interface 128 can be operatively configured to communicate with components of the system 100. For example, the communication interface 160 can be configured to retrieve data from the at least one processor 112a-b or other devices, transmit data for storage in the memory 132, retrieve data from storage in the memory 132, and so forth. The communication interface 128 can also be communicatively coupled with the at least one processor 112a-b to facilitate data transfer between components of the system 100 and the components outside of the system 100 (e.g., the non-system components of an aircraft 144). It should be noted that while the communication interface 128 is described as a component of the system 100, one or more components of the communication interface 128 can be implemented as external components communicatively coupled to the system 100 via a wired and/or wireless connection. The communication interface 128 can also include and/or connect to one or more input/output (I/O) devices.

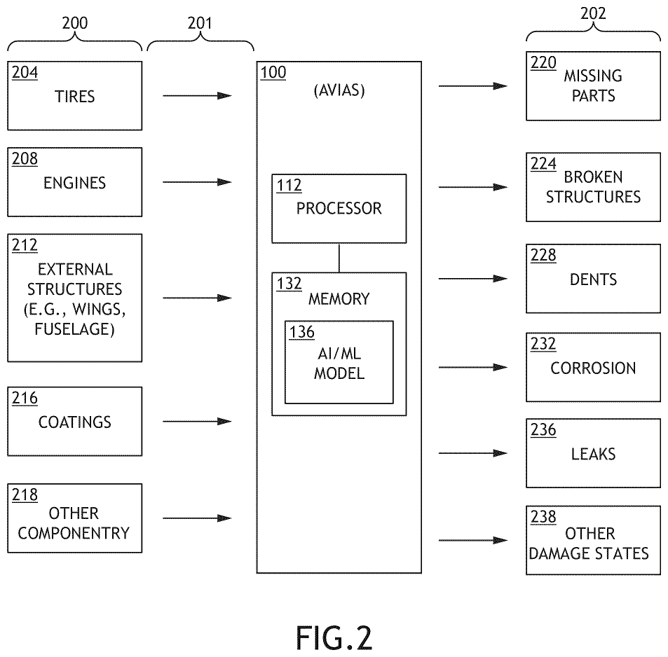

In embodiments, the system 100 is configured to sense an aspect of an aircraft component 200 (e.g., via the sensor 104 and/or microphone 116), analyze data created by the sensing (e.g., AVIAS output data 201), and report the results (e.g., damage state 202 of the aircraft component) of the analysis to the operator, as shown in FIG. 2. The aircraft component may include, but not be limited to, tires 204, engines, 208 external structures 212 (e.g., panels, wings, tail section, fan blades, vertical stabilizers and horizontal stabilizers, fuselage, and windows), coatings 216 (e.g., paint, composite layers), and other components. Once the system 100 receives the AVIAS output data 201, and analyzes the AVIAS output data 201 via the AI AND/OR ML models 136, the system 100 generates and/or infers a damage state 202 that may include, but not be limited to, missing parts 220, broken structures 224, dents 228, corrosion 232, leaks 236 and other damage states 238. These damage states 202 are then reported back to the operator (e.g., via the first display 108 or edge device 120) and/or placed in memory 132 for further analysis, storage, or other use.

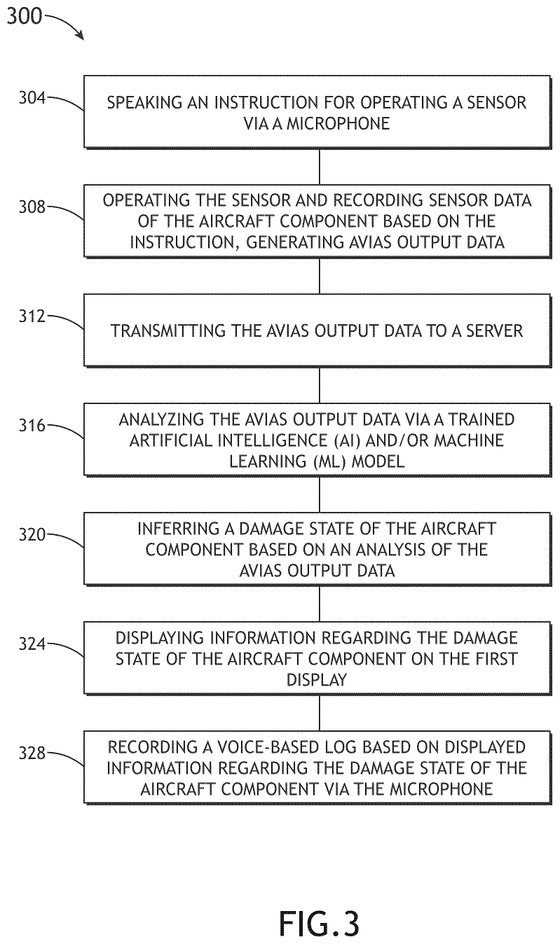

In embodiments, a method 300 for using the system 100 to assist in a check of aircraft is disclosed, as shown in FIG. 3. The method 300 may be used for assisting an operator (e.g., mechanic) in the checking of a vehicle for safety and operation. In situations where the system 100 has been cleared for use for pre-flight checks, the method 300 may be used in a pre-flight check protocol.

In embodiments, the method 300 includes a step 304 of speaking an instruction for operating a sensor 104 via the microphone 116. For example, the operator may speak into the microphone 116 instructing the sensor 104 (e.g., a 2D camera) to record an image of a wing panel. In another example, the operator may vocally instruct a command to active the illumination source 122, such as an ultraviolet UV source 122, before instructing the sensor 104 to record the image. The system 100 includes a speech-based and/or other AI and/or ML model and or proprietary algorithm that can be used to decipher the speech or other input from the operator in order to determine the instruction that the operator is giving to the system 100.

In embodiments, the method 300 includes a step 308 of operating the sensor 104 and recording sensor data of the aircraft component 200 based on the instruction, generating AVIAS output data 201. For example, the sensor 104 (e.g., a camera) may record a portion of the wing that the operator is facing (e.g., via the HWD that includes the sensor 104). The AVIAS output data 201 may include image data and/or metadata. The AVIAS output data may also include initial analysis data performed by the sensor 104 and/or microphone 116.

In embodiments, the method 300 includes a step 312 of transmitting the AVIAS output data 201 to the server 140. The server 140 may include a local server or a cloud-based server.

In embodiments, the method 300 includes a step 316 of analyzing the AVIAS output data via a trained artificial intelligence (AI) and/or machine learning (ML) model. For example. the one or more processors 112a-b may be loaded with a trained AI and/or ML software model that is used in the analysis of the AVIAS output data.

In embodiments, the method 300 includes a step 320 of inferring a damage state of the aircraft component based on an analysis of the AVIAS output data. For example, the system 100 may infer that the image of the portion of the wing has a dent 228 based on the AI and/or ML analysis of the AVIAS output data.

In embodiments, the method 300 includes a step 324 of displaying information regarding the damage state of the aircraft component 200 on the first display 108. For example, the one or more processors 112a-b may send a message (e.g., as overlaid visual text) regarding the dent 228 in the aircraft wing to the first display 108 as the operator is looking at the wing through the HWD. In this manner, the operator is looking at the aircraft component 200, and in real-time receiving an indication of the damage state 202 of the aircraft component 200.

In embodiments, the method 300 includes a step 328 of recording a voice-based log based on displayed information regarding the damage state 202 of the aircraft component 200 via the microphone 116. For example, when the operator receives the message from the system 100 that the aircraft wing has a dent 228, the operator can: record a message affirming the damage state 202, instruct the sensor 104 to reassess the aircraft component 200, record a voice-log that includes an instruction to initiate a repair of the dent 228, and/or instruct the system 100 to send the information regarding the damage state to a specific archive. Many other actions of the operator are possible using the system 100.

In embodiments, the trained AI and/or ML model may be trained using supervised learning for speech analysis and/or damage detection aspects of the system 100. For example, in regard to speech analysis, the AI and/or ML models may be trained or retrained using operator voices. In another example, in regard to damage detection, the AI and/or ML models may be trained or retrained at least in part from data received in the field during use. These supervised training methods using operator voices and in-the-field data may include transfer learning techniques, where knowledge learned from a task is re-used in order to boost performance on a related task. Types of transfer learning include, but are not limited to, instance-based learning, mapping-based learning, network-based learning, and adversarial-based learning. Algorithms used for transfer learning include, but are not limited to, Markov logic networks and Bayesian networks. In some instances, unsupervised learning techniques also may be used to train the AI and/or ML models. The training of the AI and/or ML models may be performed by one or more processors 112a-b of the system 100, processors outside of the system (e.g., such as during pretraining), or both.

In embodiments, the AI and/or ML model, such as the AI and/or ML model for speech analysis, may use transformer model techniques for detecting and comprehending speech commands. The transformer model is a deep learning architecture based on a multi-head attention mechanism. In some instances, the transformer model is considered as having both unsupervised or self-supervised learning (e.g., for pretraining) followed by supervised fine-tuning. The transformer model is of particular use for the automation of checkpoints within the system 100.

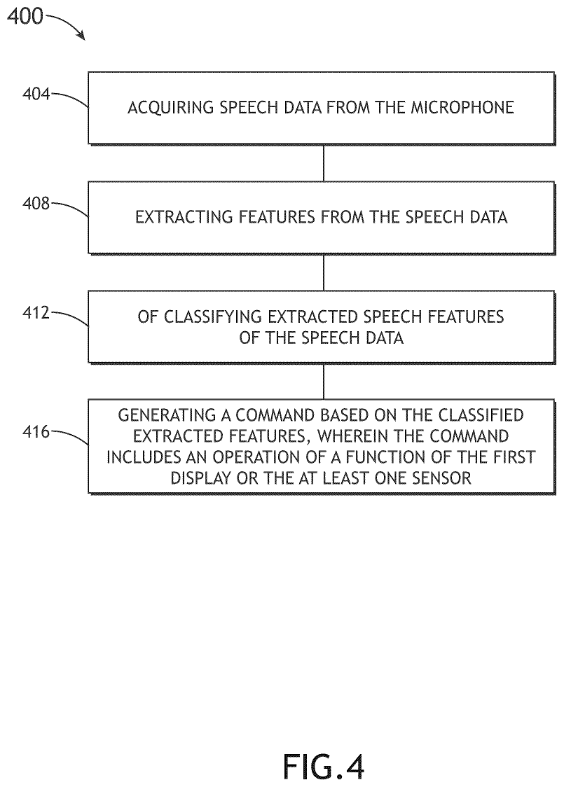

In embodiments, a method 400 for processing speech from the microphone 116 is disclosed, as shown in FIG. 4. One or more steps of the method 400 may be performed via one or more of the at least one processor 112a-b (e.g., within the microphone 116, or within the server 140).

In embodiments, the method 400 includes a step 404 of acquiring speech data from the microphone. In embodiments, the method 400 includes a step 408 of extracting features from the speech data. In embodiments, the method 400 includes a step 412 of classifying extracted speech features of the speech data. In embodiments, the method includes a step 416 of generating a command based on the classified extracted features, wherein the command includes an operation of a function of the first display or the at least one sensor 104. One or more of the steps 408, 412, 416 of the method 400 may be performed via a trained speech analytics model residing within the HWD.

### EXAMPLES

The following examples are not intended to limit the scope of what the inventors regard as various aspects of the present invention.

### Example 1

Inspection Supplementation System and Method. This system and method are related to supplementing manual inspection with computer-driven visual inspection and checking of aircraft exteriors and systems before takeoff or after landing using advanced vision systems, analytics, and augmented reality. These supplementing systems and methods enable better inspection, analytics, alert generation, maintenance recommendation, and record keeping. These new systems and methods only supplement the current manual inspection carried out by field maintenance personnel and recommended by authorities and performed today in the field.

Present Scenario/Solution. The FAA's AC-43-2041 defines four levels of visual inspection as follows: Level 1. Walkaround: The walkaround inspection is a general check conducted from ground level to detect discrepancies and to determine general condition and security. Level 2. General: A general inspection is made of an exterior with selected hatches and openings open or an interior, when called for, to detect damage, failure, or irregularity. Level 3. Detailed: A detailed visual inspection is an intensive visual examination of a specific area, system, or assembly to detect damage failure or irregularity. Available inspection aids should be used. Surface preparation and elaborate access procedures may be required. Level 4: Special Detailed: A special detailed inspection is an intensive examination of a specific item, installation, or assembly to detect damage, failure, or irregularity. It is likely to make use of specialized techniques and equipment. Intricate disassembly and cleaning may be required.

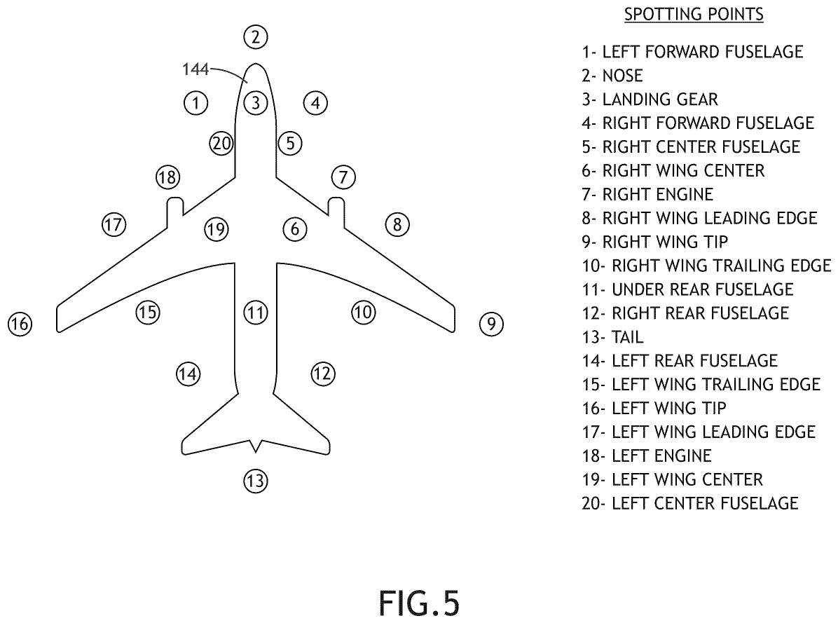

The purpose of Level 1 Walk around Check/Outside Check is to determine whether there is a malfunction in the current state of the aircraft that may cause problems on the next flight. A malfunction detected during the walk-around check must be resolved, thus increasing flight safety. The current solution is shown in FIG. 5.

Areas of aircraft that need to be checked manually include door frames, passenger, cargo compartments, drains, engines, auxiliary power unit (APU), leading edges, wings, trimmable horizontal stabilizers (THS), slats and flaps, landing gear, brakes, tires, engines air intakes and fan blades.

The following are the few items that need to be manually checked by maintenance personnel or crew: unremoved placards/pitot tube covers, cargo and servicing access doors areas that have been operated during the aircraft ground time, evidence of leaks of hydraulic, fuel, oil or water/waste, the condition of aerodynamic seals, wear and erosion, Foreign Object Damage (FOD), and bird strike, missing service doors, access panels, or static wicks, structural damage (Dents), anomalies, vent obstruction, lightning strike damage, taxi lights, landing light, making sure that they are clean and that the glass is not cracked, and removal of chocks.

Limitations of the Current System. The current aircraft exterior checks are manual, human-based, checklist-driven inspections and actions, which are easy to miss due to oversight and human error. Also, the environmental conditions play a role especially low light conditions play a major setback for effective inspection. Reasons for inspection errors include distractions, as anything from a phone call to a service interruption can be a distraction. This human factor is a catch-all for anything that is irrelevant or disrupts the safety process. Another reason for inspection errors is fatigue. According to a Federal Aviation Association study, maintenance personnel sleep for an average of five hours per night. That's three hours less than the recommended amount, and it can negatively affect work performance. Another reason for inspection errors includes pressure and stress. Finding and keeping trained personnel in a specialized field can be a challenge. Smaller teams can result in higher pressure on individuals. Another reason for inspection errors is communication. Communication can be as small as passing off work during a shift change. Maintenance personnel can help each other by documenting issues and speaking up when needed. Another reason for inspection errors is the operating environment. Sometimes the inspections carried out are done during odd hours, in bad weather, and do not have sufficient illumination levels to carry out the task efficiently and are prone to judgment errors. Another reason for inspection errors includes human eye constraints. It is difficult to detect miniature defects of the fleet components like creases, bends, corrosion, moving and rotational components, etc. with the naked human eye due to naked eye limitations.

The current practices of an Aircraft inspection process are labor intensive. This routine job requires several thousands of component inspections to be performed almost every day. The checklists are hardcopy and need to be filled manually and stored manually leading to overhead and increasing the possibilities of oversight. The record-keeping exercise including storage of the photos and visuals is also manual where field maintenance personnel manually capture the photos & videos using a camera and store the information by manually transferring the data to computer databases.

Proposed Solution. The proposed solution is the Aircraft Visual Inspection Assist System (AVIAS). AVIAS is a hands-free system which to be worn on the head (or) as a part of a helmet to assist the maintenance personnel with aircraft external inspection. This also comprises applications running on the cloud, communication interfaces, and a hands-free command system.

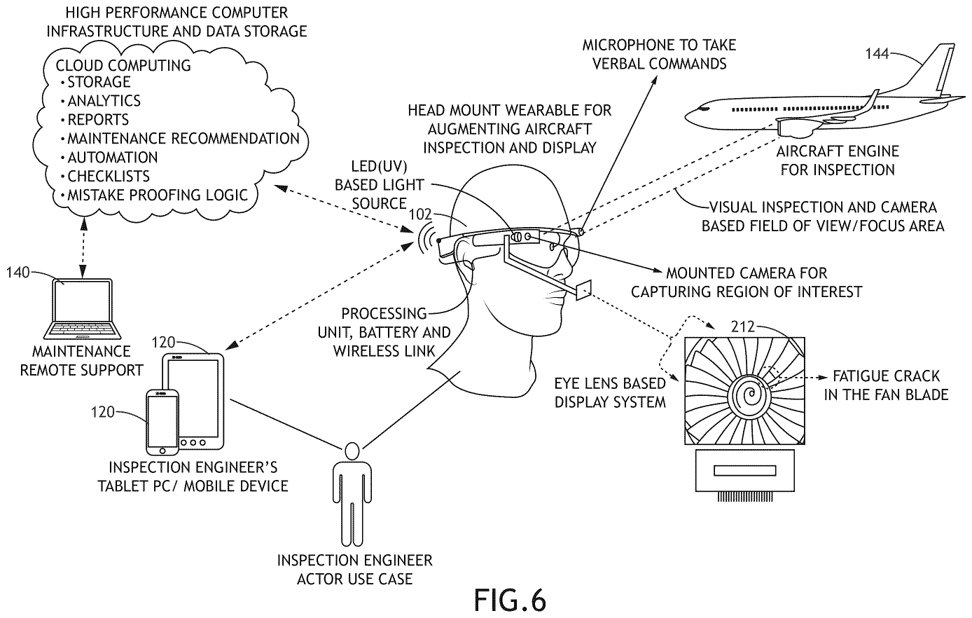

This visual assist also known as AVIAS comprises of sensors 104 (e.g., high-definition cameras/CMOS Sensors, thermal cameras/sensors, adjustable display optic in front of one eye (called eye lens)), a microphone 116 to accept command (in hands-free mode), a processing unit for edge computing, onboard storage memory and a wireless communication interface to communicate data and commands to and from a cloud computing infrastructure. The system comprises an optional handheld system either in the form of a mobile or tablet device capable of replicating the display on the eye lens and providing additional capabilities for better visuals than the eye lens. The system also comprises an LED-based light source with an on/off capability that accepts voice or other commands to illuminate the surface under inspection. A high-level setup of the AVIAS and its communication with the cloud is shown in FIG. 6.

The AVIAS system is a distributed system suitable to assist the infield maintenance personnel with their aircraft inspection process using augmented reality and process automation. In this case, the real-world objects seen by maintenance personnel are overlayed by computer-generated information to support the maintenance personnel with additional information. Along with this it also provides camera-captured images and videos, zoom in/zoom out, and analytics capabilities with novel algorithms to perform the inspection more effectively. The analytics capabilities are additional features that are run only on a selection basis by maintenance personnel to investigate the problems or to gather better insight into damages and problems.

In this novel setup the high-definition camera/CMOS Sensor and thermal camera/sensor are fixed to a strap (e.g., HWD) that's wearable on either helmet or head. The high-definition camera/CMOS Sensor and thermal camera/sensor capture video, photos, or thermal images of the aircraft exteriors under inspection.

The system 100 includes an eye-lens-based display mounted on the same strap. This eye lens display is placed in front of one of the eyes of maintenance personnel and provides visuals of the aircraft exteriors under inspection. The captured videos, photos, or thermal images of the aircraft exteriors are fed back on the eye lens as augmented reality with capabilities to zoom in and zoom out using voice command for better inspection.

The strap also contains a microphone capable of capturing maintenance personnel's voice and accepting commands for capturing video, photo, thermal images, zoom in, zoom out, recording of the aircraft exteriors under inspection, storage to the cloud, referring checklist for inspection, etc. The microphone captures the voice and sends it to the processes built into the strap for processing to decipher the command. The microphone is also capable of capturing sound generated from aircraft systems like engines for evaluation.

The strap contains a local processor 112a that accepts input from the microphone and processes it to generate commands. The command is generated using machine learning techniques where speech models are trained to interpret the command from human speech and convert them to computer commands. The processor commands the camera system for video, image, and thermal image capturing. It also switches the LEDs for light sources. Along with this, the strap contains a battery to power the processor and peripherals including the camera, microphone, communication interface, etc.

The strap also has a wireless communication interface capable of connecting to the remote server or cloud using a wireless communication protocol. This enables captured image, video, audio, and inspection records storage on the server/cloud. It also enables sending the information to the cloud for processing and getting enhanced data for decision-making like deeper detailed visual inspection, damage classification, etc. It also supports the inspection personnel with automated checklists, manuals, and records for their job to be displayed on the eyepiece.

The system comprises an application running on the personal digital assistant/mobile/tablet device with a display to fetch the visuals from the server and display them in enhanced vision. This is to enable larger zoom-in views of the visuals for better investigation and check the damage. The maintenance personnel can operate this display device manually using their hands.

The cloud computing infrastructure helps with record keeping, databases, and processing for running algorithms developed as part of this solution on acquired images and videos to provide deeper insights for damage detection and maintenance. The details of the setup and novel aspects of the application are documented below.

In this invention the technology related to vision sensors, digital signal processing, image processing, machine learning, robotic process and embedded devices are integrated and orchestrated to develop a distributed system and applications which supports the field maintenance personnel to perform aircraft exterior inspection in a very effective and foolproof way. This system is called AVIAS (Aircraft Visual Inspection Assist System). First, the inspection personnel perform a manual, eye-based inspection of the aircraft exterior, and if something suspicious is found, the maintenance personnel initiate the AVIAS to perform a deeper inspection and receive a detailed analysis of the situation.

The following systems, subsystems, and components may be incorporated into the AVIAS.

The system 100 may include a strap 102 (e.g., HWD), a narrow piece of material made of plastic (e.g., polypropylene), or polyester/polyethylene terephthalate (PET) that can be tied to the headset/helmet. The strap, or strap unit, may have a built-in camera having 2D/3D and/or thermal camera for focusing the object, processing unit, battery, and microphone. These Adjustable straps are ergonomically designed for maintenance personnel to use without discomfort.

Vision Camera (e.g., sensor 104). A vision camera is a special type of camera designed to “see” and understand images the way humans can see; It is mounted on the head strap 102. Smart cameras are used to help machines or computers to make decisions based on what they see. These smart cameras (2D and 3D) capture visual information from the surrounding environment, it can be under potentially challenging lighting conditions, and provide high-resolution images with illumination, precise color accuracy, and optimal resolution. There are 3 types of cameras fitted in the AVIAS wearable strap 102 and are described in detail below:

The system 100 may include 2D cameras that capture images in two dimensions, representing the visual scene as a flat image. 2D cameras are widely used in machine vision systems for various tasks, including object detection, pattern recognition, positioning and alignment, measurement, and optical character recognition (OCR), among others. They provide spatial information about the objects or scenes they capture, allowing for the analysis and processing of the images to extract valuable data for inspection and quality control applications. These 2D cameras can vary in resolution, pixel size, sensor type, frame rate and connectivity options. They often use technologies such as Charge-Coupled Device (CCD) or Complementary Metal-Oxide-Semiconductor (CMOS) sensors to convert light into electrical signals, which are then processed to generate 2D images. Machine vision 2D cameras play a fundamental role in object detection.

The system 100 may include 3D cameras. 3D cameras are a type of camera specifically designed to capture three-dimensional information about objects or scenes. 3D cameras use advanced technologies to measure depth (e.g., Z-axis dimension) in addition to height and length, and create a three-dimensional representation of the object's shape and spatial characteristics. They are used in tasks such as 3D inspection of objects. in addition to dimensional measurements and metrology, these cameras leverage different techniques to capture depth information, including stereo vision, time-of-flight (ToF), and structured light profile scanning. In this system 100, 3D cameras help in generating a point cloud or depth map that represents the three-dimensional structure of the object under check. These 3D images help in identifying the dents on the body, identifying paint damage, and/or identifying the severity of damage, etc.

The system 100 may include thermal cameras. Thermal cameras, also known as infrared cameras or thermal imaging cameras, are widely used in machine vision for various applications that require capturing and analyzing thermal information. The captured thermal images represent the temperature distribution across the object, with different colors or shades representing variations in temperature.

In machine vision applications, thermal cameras are particularly useful for tasks that require temperature analysis, such as monitoring heat patterns or identifying hotspots and temperature anomalies in an aircraft body. By utilizing machine vision thermal cameras, maintenance personnel will review heat mapping generated by AVIAS to identify areas of excessive temperature, detect potential malfunctions or equipment failures, and implement proactive measures to prevent damage or accidents.

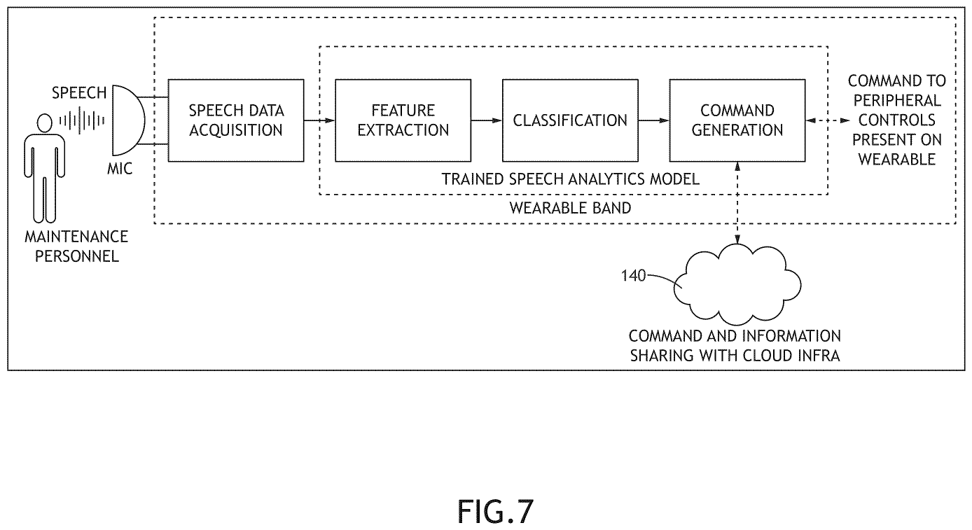

The wearable strap 102 comprises a microphone 116 to capture the speech of the maintenance personnel. It provides the digital input to the processor via speech data acquisition system. The processor splits the words based on pauses and passes the acquired data from the speech data system to a trained speech analytics model. The trained speech model analytics performs feature extraction from the acquired data and applies it to the classification module to decipher the voice command. The command generation module generates the command identified by the classification module and shares it with either the cloud to receive the required information/data or controls the peripherals based on the command. A high-level setup for the Microphone, command identification, and processing module is shown in FIG. 7.

The speech analytics model is a machine learning model trained for performing the feature extraction and identifying the voice commands from the speech of the maintenance personnel. It comprises a variety of commands like—switching on the camera, switching off the camera, showing the checklist, capturing the image, zooming in the image, zooming out the image, switching to thermal mode, inspecting the oil spillage, providing the damage analytics report, etc. The speech analytics model is trained offline in high-performance computing environments and then the trained model is loaded on the wearable computing environment.

When the speech analytics model application running on the wearable is unable to process the speech and generate the command, it directs the speech to the high-performance computing capability cloud and puts it to work for generating the command. The command identified by the cloud is sent back to the wearable for processing.

The wearable strap 102 comprises a rechargeable battery that is used for powering the cameras, processor, wireless interface, LEDs, microphone, lens display, and all other peripherals mounted on the strap locally. These batteries have high energy density and are made up of carbon materials for flexible battery packaging.

The strap 102 comprises at least one processor 112, such as a low-powered processor, and its peripherals as in case of a system on a chip. Here processor 112a-b is used to process the image and videos taken by the camera and send these data to the cloud-based computing algorithm. Also, this processes the voice command of the operator to perform the desired action. The processor also controls the various peripherals mounted on the strap 102 including wireless interface, LEDs, and lens display. It also monitors the battery power levels and informs the maintenance personnel about the battery's charged status and remaining functioning time.

This system 100 provides wireless-based communication between a head wearable, handheld device, and cloud infrastructure (e.g., a wireless interface). The wireless connection established between the various devices like wearable, handheld devices, and cloud infrastructure may be configured using star topology where these wireless devices communicate directly with a central gateway and use the central gateway bridge to talk to each other. This helps reduce the power consumption of these devices and enables also reliable and high-speed communication between these devices.

The handheld device in this setup may include an additional mobile phone, personal digital assistant (PDA), or a tablet computer—that maintenance personnel carry along with them to the field. When it is difficult to analyze the images and videos on a wearable personal lens, the maintenance personnel can use this handheld device to get the required information and view the damages and defects clearly on a zoomed field of view. This handheld device is interfaced over wireless with the wearable device, remote inspection terminal, and cloud computing infrastructure for coordination and synchronization to send the receive commands and information and to display the items of interest for inspection. It also helps show the automated checklist support and fill the checklist after the required action.

AVIAS uses cloud computing-based infrastructure to suffice the huge storage requirements and to run computing extensive software applications required for the complete functioning of the setup. The details of each of the objectives are provided below:

The videos and images captured during each inspection cycle are stored on the cloud for records and evidence (e.g., memory 132). They are also accessible during later phases for references. The evidence is searchable using attributes like type of damage, severity of damage, timeline of recording, etc. The storage is also used for storing the digital checklist filled by the operator during the inspection. The storage also contains copies of the distributed applications required to run AVIAS. The stored data are retrieval and supports with forensic as required in future.

Cloud resources host image and video enhancement algorithms which take images and videos as inputs and enhances them for better visibility and clarity. The image and video algorithms support improved sharpness, stabilization, masking, interlacing, enlargement, adjusting saturation, brightness, contrast, hue, fade, and vignette, upscaling, and applying various types of filters.

The AVIAS system runs on cloud-based infrastructure primarily with another distributed application running on wearable edge devices. When the operator wants to perform a deep dive into the identified problem, images and videos are taken and transmitted to the AVIAS system. AVIAS system processes these images and videos and returns the analytics report to the handheld devices or head-mounted display of the wearable. The result of this analysis helps the operator to determine the exact problem and severity of it for maintenance actions.

The AVIAS system provides data distribution. If the user wants to fetch the specific inspection report or images for reference, a query is sent to the cloud system for the data. The distributed system produces the required information and shares it with the user on the head wearable display system or hand-held device. For the maintenance remote support, the data is made available on the remove support terminal/personal computer. This makes the distribution of data among different stakeholders efficient and easy.

AVIAS comprises distributed applications scattered across wearable, cloud, communication interfaces, handheld tablets, and remote maintenance support. In some embodiments, the cloud is replaced with on-premises storage and high-performance computers. The details of each of these unique applications distributed and running across the various edge and cloud devices are mentioned in detail here.

Voice-based command applications enable the operator to do tasks based on voice commands. For example: if the operator wants to take an image, then he gives a voice-based command to camera to capture the image. If the operator wants to store the captured the image on the cloud with some specific name, then he gives a voice-based command to do the storage operation. Similarly, the maintenance operator can provide commands to enlarge/zoom in the image. The operator can also provide commands to zoom out, change the focus, change the mode of camera from vision to thermal, review the checklists and perform many other operations. This part of the application runs on wearable for getting the voice and coordinates with the cloud to get the voice to digital command conversion using speech analytics.

Image/Video enhancement applications help in enhancing the image/video quality to support correct and detailed analysis of the identified problems and damages. This application runs on wearable and coordinates with cloud infrastructure to improve sharpness, stabilization, masking, interlacing, enlargement, adjusting saturation, brightness, contrast, hue, fade, and vignette, upscaling and applying various types of filters to get detailed information of the damages.

Analytics Algorithms applications will perform analytics on the captured images and videos. If required, it gets the images and videos enhanced. This application comprises multiple machine-leaning-based algorithms trained on normal and damaged image and video data to identify and classify different kinds of problems. It helps with diagnostics and prognostics of the damage.

When the operator feeds images and videos for further analysis, the application analyzes the issue and returns a detailed report to the operator to act on it using a report generator application.

Data distribution applications help in managing the distributed data among the distributed devices, infrastructures, systems, sub-systems, and applications and integrate them for an efficient and dedicated operation for the AVIAS to complete its responsibilities.

AVIAS (e.g., the system 100) contains provisions to throw light on the area/exterior of the aircraft under inspection. For this, the wearable is fitted with LEDs capable of generating and emitting different types of light with brightness control. These LED lights are switched on and off by maintenance personnel using voice commands. The luminosity, color, and focus area of the light are also controlled by the maintenance personnel using voice commands. The AVIAS wearable may also comprise ultraviolet and black light emitters. This is to detect any oil leakage and when required the maintenance personnel switches it on and off using voice command.

The AVIAS display (e.g., first display 108) may show the following views on the eye lens for the maintenance personnel to view and select.

Normal View. This view is like a normal eye view and how we visualize a generally captured image or video using a vision camera. This view works in both real-time telecast and the recorded version. This view provides capabilities to Zoom in or Zoom Out the displayed images or videos.

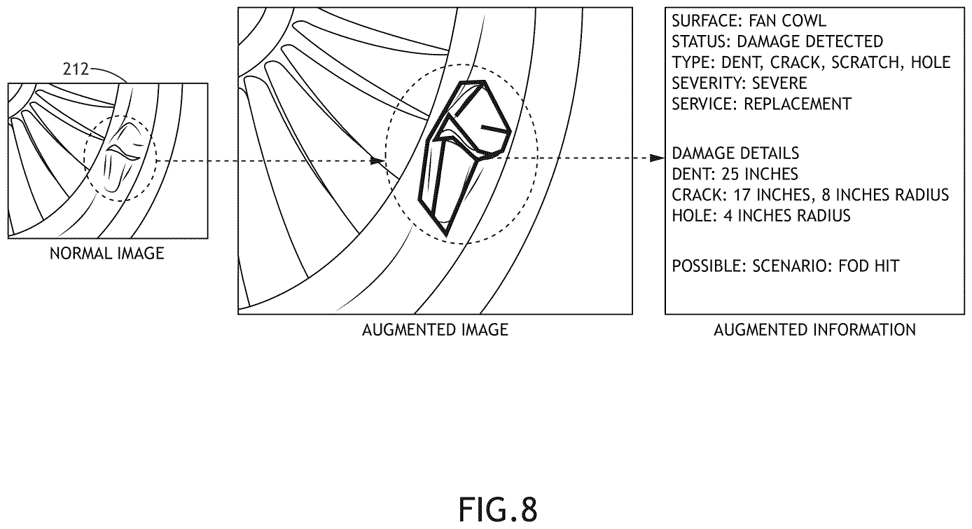

Augmented View. In the augmented view the normal view images and photos are overlayed by geometric shapes, sizes, lines, and a plethora of other information like angle, diameter, axis, depth, etc. to support the maintenance personnel with the information required to make decisions related to damages and maintenance. It also provides information related to the type of damage, damage classification, severity, etc. It also displays information related to damages like type of damage, span/size of damage, etc. A sample of an augmented reality-based view is shown in FIG. 8.

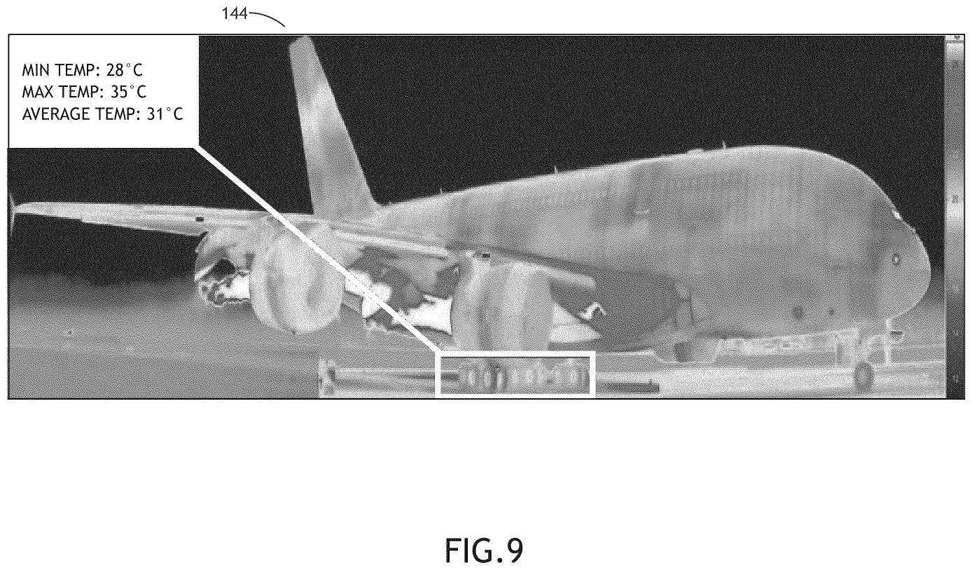

Thermal View. Thermal mode view is an additional view in this invention that supports displaying the thermal images of the components/surfaces/exteriors of the aircraft under inspection. The Thermal mode inspection supports with detection of damages in composite structures. It supports infrared thermography. The thermal inspection also helps in detecting moisture, gaps, leakages, overheated zones, wear, and tears. It helps with both detecting the current damage and prognosing the future damage that could happen due to current conditions. It is very helpful to inspect systems and components like tires, brakes, wheels, rims, landing gears, engine exhaust, APU exhaust, etc. A sample of thermal imaging-based inspection of aircraft tires and other components is shown in FIG. 9. In some cases, the thermal images are overlaid onto normal images using data fusion techniques and filtering to depict the damages and problem areas clearly to the maintenance engineer.

AVIAS provides an ability to play the recording of the images, videos, and thermal images captured during the inspection by operator on the eye lens of the strap 102 or handheld device for detailed reference and investigation. It can also replay the items of interest along with a timeline for the inspection records stored by the maintenance personnel. These images and videos are sent for processing to cloud-based computing algorithm for detailed investigation into the identified problem. This invention also provides the facility to play the recorded images and videos post analysis by cloud-based computing till the time the observation was made, and damages were identified. The recorded version also enables saving the images and videos with labels which allows for retrieval of the recording with specifications and type of damages.

AVIAS provides an ability for scrolling and filling out the digital inspection checklist (e.g., an automated checklist) based on the voice command given by the operator. When the operator starts an inspection process, the operator can pull up the checklist using voice command and start filling the checklist items one by one after process completion and using voice command. Based on voice command the operator can provide details like which part he is inspecting and all the observations. The checklist can auto scroll to the next item/inspection once a process is completed. The checklist will be stored in the cloud and can compare the checklist when there is an issue and give different reports. Checklists are stored in the cloud and can be compared with previous checklist records and inspection records when any issue is identified.

AVIAS provides an investigative menu to deeply investigate any issue or damage. This is a supplement system that helps maintenance personnel to narrow down the problem area. If the maintenance engineer notices any problem or damage, he can take the image/video of the component/surface under investigation and initiate a deep investigation that applies machine learning techniques on the captured image/video to support maintenance personnel in detecting the type of damage and possible cause of the damage like corrosion, dent, hole, etc.

The aircraft tarmac around check points may be divided into different zones Front Left, Front Right, Back Left, Back Right and Bottom Left, Bottom Right side of aircraft. These zones are in such a way that maintenance personnel walk around the aircraft and cover all the walk around check points 1 to 20 shown in FIG. 5. The Camera focus are configurable based on aircraft structure and airport need. Even the zones can be increased and decreased for optimized and better coverage based on the requirements of airlines and airport authorities.

In this system 100, different types of manual inspections can be supplemented with camera-based AVIAS inspection. Those are detailed in the examples below.

### Example 2

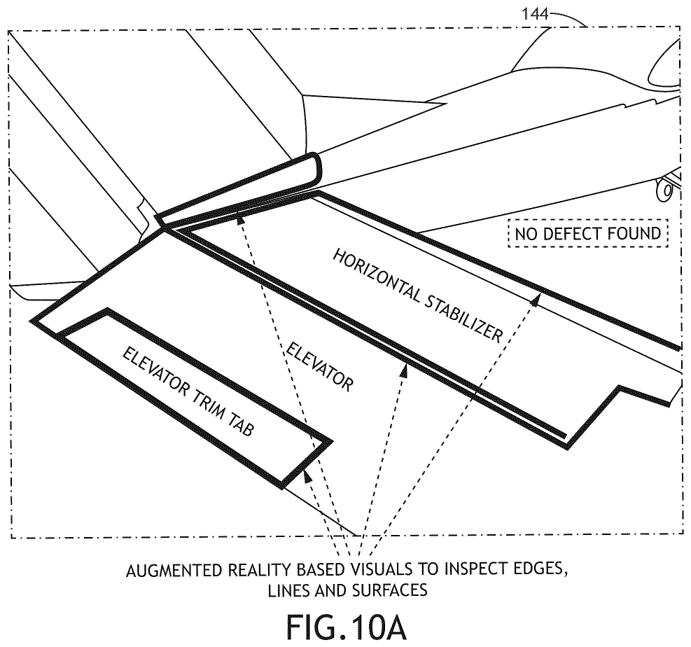

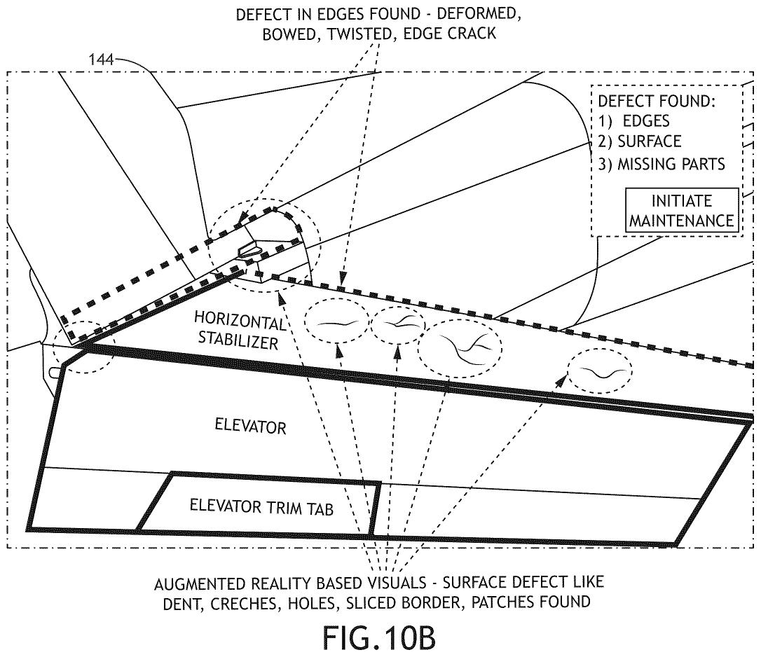

Control surfaces structural evaluation. Though aircraft are designed to withstand high wind blows when flying or in parked conditions outside the hangar, damage may still occur. Sometimes these damages are not obvious and require special inspection including visual inspections. AVIAS in this type of inspection plays a role in the identification of structural damages like bending, cracks, and disbanding. AVIAS assists in overlaying the image of the surface under inspection over predefined augmented reality-based surfaces and applies algorithms to detect any edge, surface, or missing part defects as shown in FIGS. 10A-10B.

### Example 3

Corrosion. Aircraft suffer from corrosion as they are exposed to oxygen, humidity, foreign objects, and harsh environments. Some of the common types of corrosion are dissimilar metals corrosion, stress corrosion, intergranular corrosion, surface corrosion, and filiform corrosion. Aircraft are inspected visually to detect these different types of corrosion and for evaluation of damage due to these phenomena.

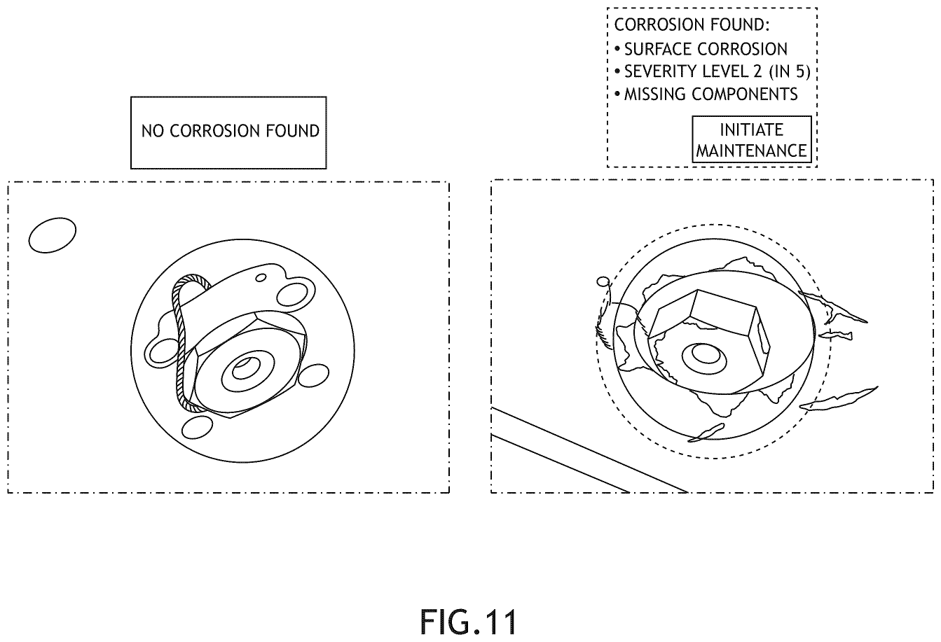

In embodiments, AVIAS is used for capturing the finer details of the aircraft surface, component, or system under inspection for corrosion identification. Once the maintenance personnel decides to inspect a surface and faces the surface, component, or system under inspection, the AVIAS system starts capturing the video and images of the item of interest in parallel and starts analyzing the visuals for greater details. It helps not only identify the corrosion but also supports the identification of different types of corrosion like surface corrosion, dissimilar metal corrosion, intergranular corrosion, stress corrosion, fretting corrosion, filiform corrosion, etc. It also helps get the details on the severity of corrosion by providing capabilities to zoom in the captured images and videos. It also provides a menu to get the details of the type of maintenance required for current condition of the corroded surface, component, or system using augmented reality, as shown in FIG. 11. In this case the maintenance personnel need to command the AVIAS system to switch to corrosion detection and analysis mode for corrosion inspection.

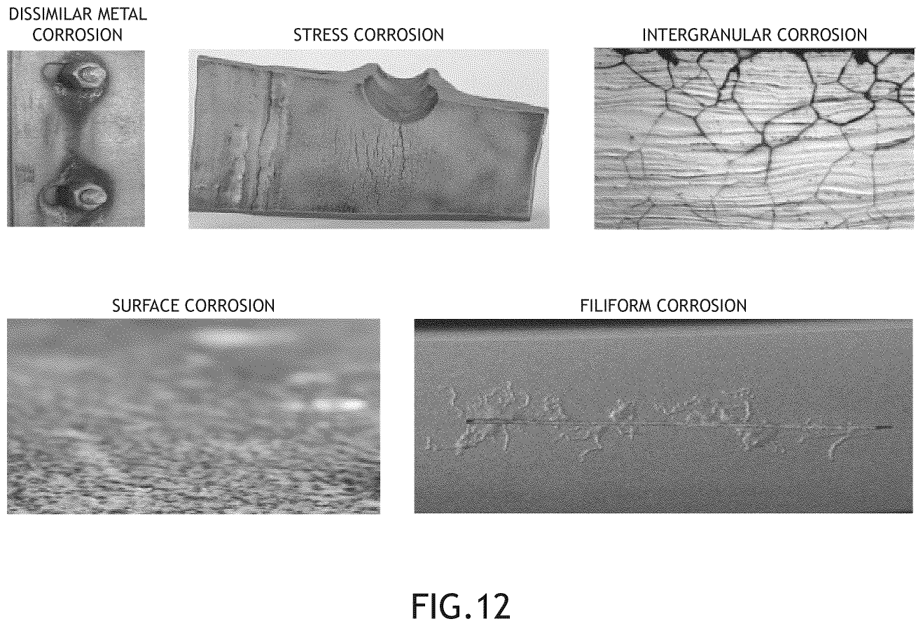

The different types of corrosion that AVIAS can detect and bring the details to the maintenance personnel are shown in FIG. 12, which include, but are not limited to, stress corrosion, intergranular corrosion, surface corrosion, filiform corrosion, and dissimilar metal corrosion. The AVIAS system may be configured to recommend different types of maintenance activities to be carried out based on the type and severity of corrosion to maintenance personnel. The AVIAS system helps label the corroded area with information to be stored for records.

### Example 4

Coating and Paint Damages. Aircraft suffer different types of coating and paint problems over time due to harsh environmental operations, UV exposure, thermal cycling, composite material, etc. The maintenance personnel perform visual inspection of the aircraft exteriors to identify and analyze the coating and painting problems. The growing coating and painting problem can pose bigger risks to the safety of aircraft over time and impact appearance and fuel efficiency in the shorter term. Hence, it is important to perform a detailed analysis of the coating and painting problems and eliminate them in a timely fashion.

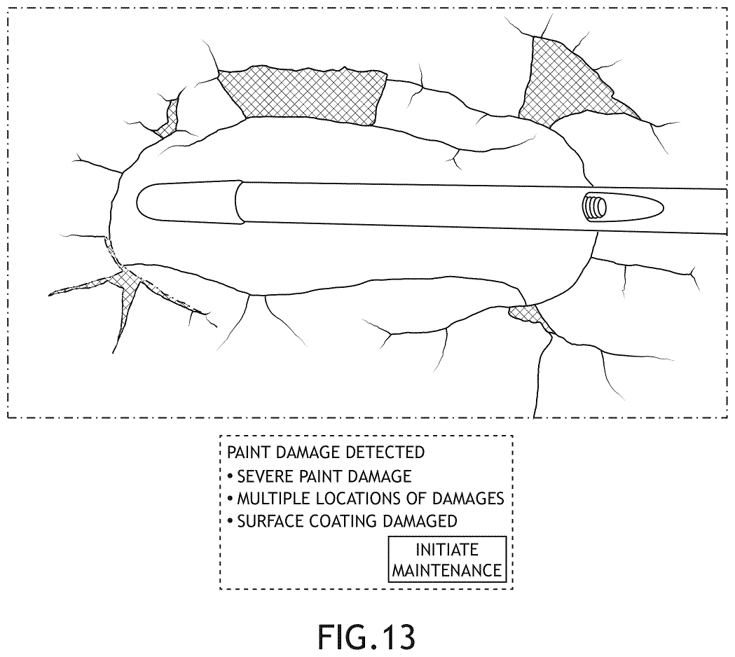

In embodiments, the AVIAS system helps the maintenance personnel with a deeper investigation into the coating and painting problem in painting inspection mode. Once the maintenance personnel identify the coating and paint problem on the aircraft with the naked eye and focus on the surface, components, or system under the problem for deeper analysis, the maintenance personnel command the AVIAS to get to coating and paint damage analysis mode. In this mode, the AVIAS captures the videos and images of the surface, component, or system in very high-resolution mode and makes it available on display to the maintenance personnel for deeper inspection. AVIAS also provides details of the problem areas, coating and painting peel off sections, tape sections and expanding problem for better insight and maintenance requirements. The coating and painting evaluation using the AVIAS system is shown in FIG. 13.

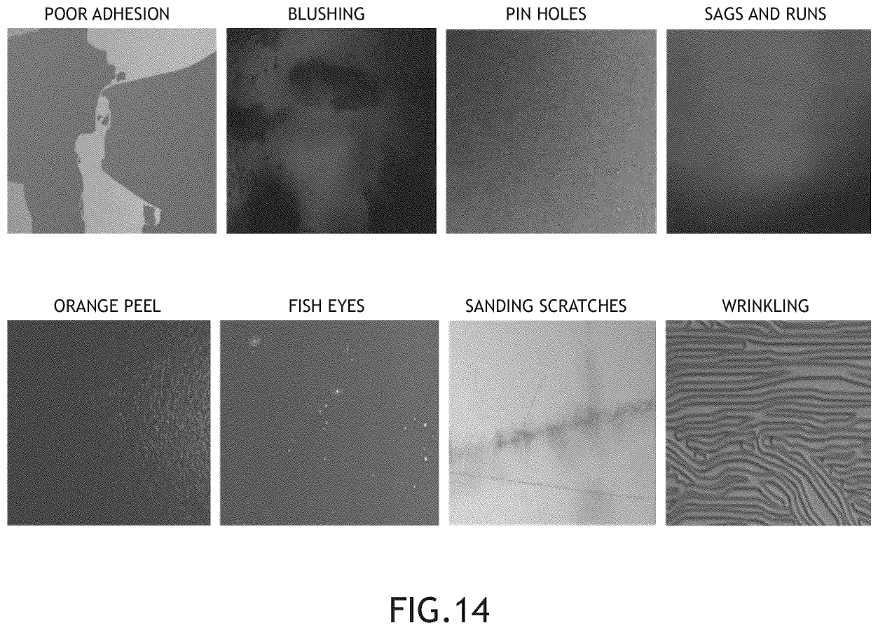

In embodiments, AVIAS is trained to identify the different kinds of paint-related damage. The different types of paint damages that AVIAS can identify are shown in FIG. 14, which include, but are not limited to, poor adhesion, blushing, pinholes, sags, runs, orange peel appearance, fish-eye appearance, sanding scratches, and wrinkling. The AVIAS system helps label the coating and painting area with problem information to be stored for records.

### Example 5

Oil Leakage. Aircraft may experience hydraulic oil leakage from actuators, engine oil leakages, and APU oil leakages. It is important to catch the minutest incident of such leakages, and it is the responsibility of field maintenance personnel to conduct visual inspection on a routine basis. Any miss to identify such incidents of leakage could lead to major damage and accidents.

In embodiments, the AVIAS provides capabilities to enable the oil leakage detection mode by maintenance personnel. In the oil leakage detection mode, the AVIAS has two different modes—normal light inspection and UV/Black light inspection. In normal light inspection, the AVIAS directly captures the videos and images. In the UV mode, the AVIAS flashes different types of ultraviolet and black light to detect oil leakages.

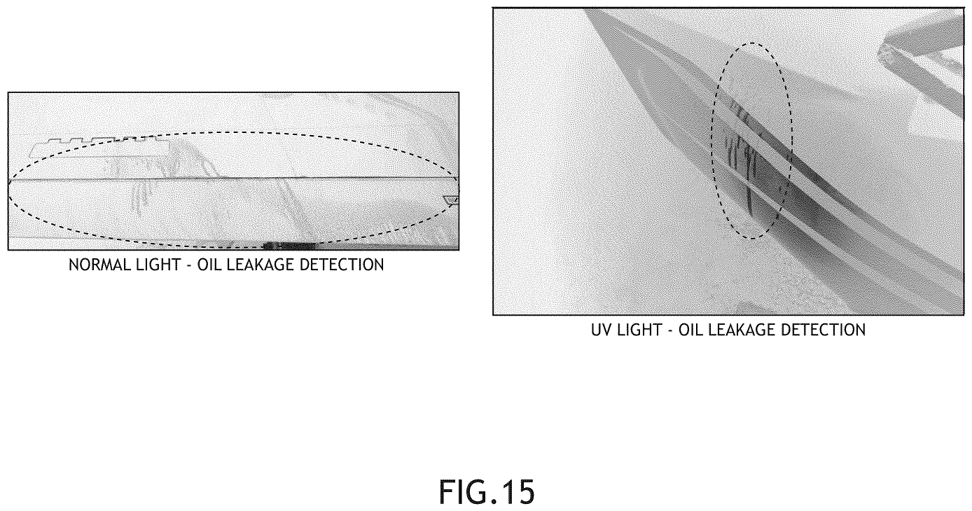

Once the maintenance personnel focuses on the surface, components, or system under inspection, the AVIAS throws ultraviolet and black light to detect any oil leakage by the maintenance personnel through his eyes. Along with this the AVIAS captures the video and images of the surface, components, or system under inspection and provides a detailed analysis of the leakage if any. It compares the obtained images with the trained models to identify any leakage problem. Examples of oil leakage detection and evaluation under normal light and ultraviolet light are shown in FIG. 15. AVIAS provides a safeguard against ultraviolet light to prevent any eye damage. For this, it keeps detecting the object in front and if it identifies eyes or humans, it switches off the UV light source. It has a trained model to identify human beings and eyes which helps it in identifying the potential problem areas and command the UV flight source to shut off.

The analytics module here is a machine learning/deep learning-based module which is pre-trained to access any damage, defect, or anomaly as is described in more detail in the below sections. The analytics is done in two phases as mentioned below. These analytics are only a guide to the maintenance personnel performing the inspection.

### Example 6

Training and Validation of the Analytics Module for Identifying the Check or Preflight/Postflight Check Violation. In embodiments, the analytic modules are trained for the classification of problems including, but not limited to, dents in the fuselage, if the fuselage is rusting, the pitot tube still has its cover on, and leakage of oil. For the training, the images of normal and anomaly/damage/dent cases are captured and labeled. These labeled images are used for training the analytics models which are later used in the field for processing the images captured from aircraft and detecting if there are any damage/dent or anomaly with the aircraft in the field. These techniques use masking and bounding box techniques to separate the aircraft exterior components under inspection. A few cases for training the models to detect damage/dent or anomaly are discussed in detail below.

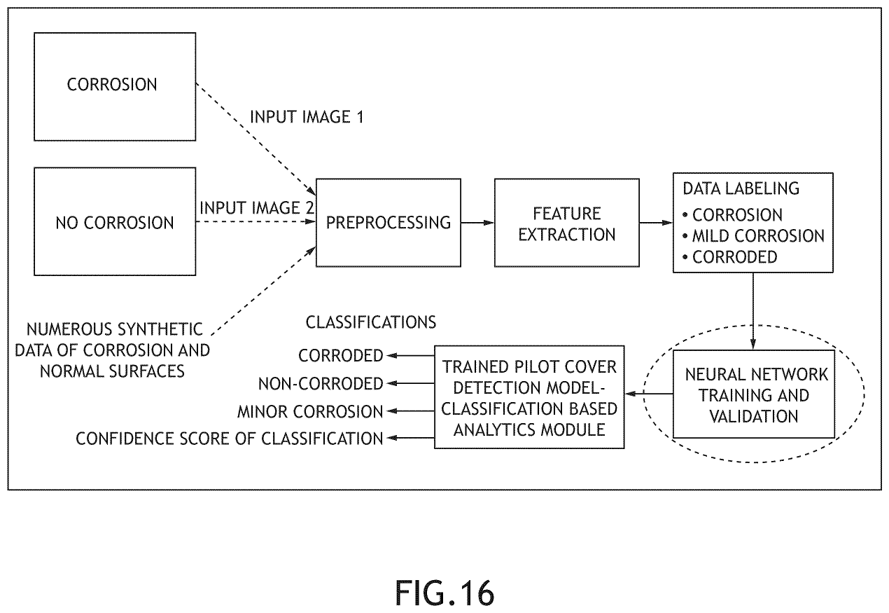

Training for corrosion detection. In embodiments, the images of corroded parts of the external aircraft body are captured and labeled with “corrosion” along with part type. Similarly, the normal part images are also captured and labeled with Normal and part types. Along with the numerous captured images of the different segments of the aircraft with the corroded and normal conditions, the partial or not severe conditions of the corrosion are also captured and labeled. These labeled images are applied to the machine learning models for training as shown in FIG. 16. Once, trained the machine learning models can detect the component and its condition—normal, partially corroded, and corroded.

The real captured images are then supplemented by synthetic data to achieve better accuracy for the detection of corrosion of different parts visible on the external surface of the aircraft. Once the required accuracy is achieved for the detection, the trained model is deployed in field for identification of corrosion happening to the aircraft external surfaces.

The models are trained to capture different types of corrosion like surface corrosion, dissimilar metal corrosion, intergranular corrosion, stress corrosion, fretting corrosion. For this the addition labels are provided with the captured training images related to type of corrosion and supports with relevant classification of type of corrosion.

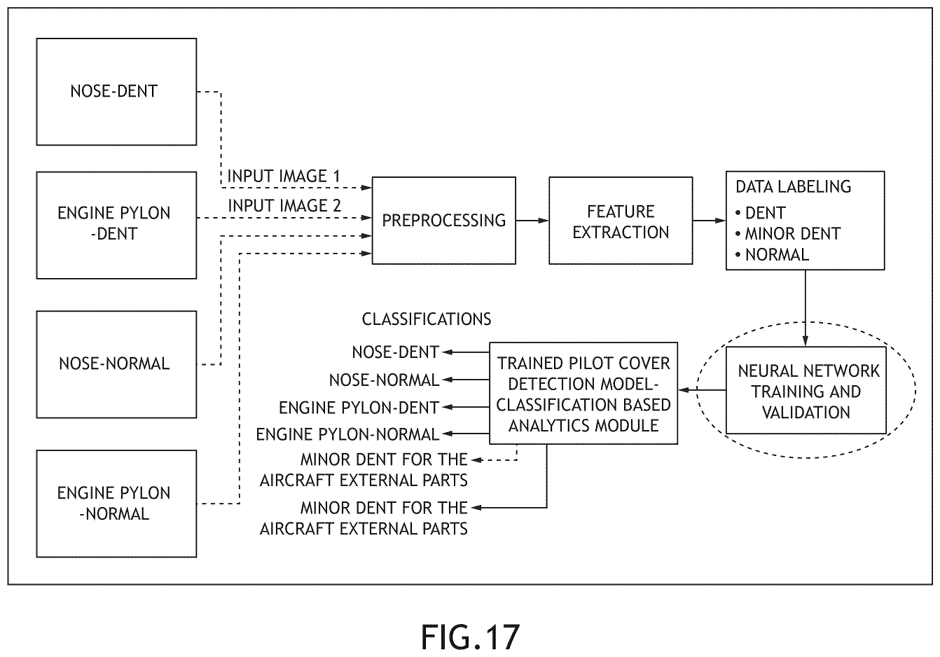

Training for dent detection. In embodiments, the images of the aircraft parts which are external to aircraft body and are dented are captured and labelled with ‘Dent’ along with part type. Similarly, the normal part images are also captured and labelled with ‘Normal’ and part type. Along with the numerous captured images of the different segments of the aircraft with the dented and normal condition, the partial/not severe/minor conditions of the dent are also captured and labeled. These labeled images are applied to the machine learning models for training as shown in FIG. 17. Once trained the machine learning models can detect the component and its condition—normal, minor dented, or dented. The minor dents do not have a big impact on the aircraft's functioning, efficiency, and safety while the big dents pose a possible threat to aircraft functioning, efficiency, and safety.

The real captured images are then supplemented by synthetic data to achieve better accuracy for the detection of dents of different parts visible at the external surface of the aircraft. Once the required accuracy is achieved for the detection, the trained model is deployed in the field for the identification of dents on the aircraft's external surfaces. In a few cases, the dents are deliberately done to the aircraft's external surfaces to capture the images and train the models.

Training for paint-related defects. Aircraft paints may peel off due to poor adhesion, poor paint quality, or primer quality. It leads to poor adhesion, blushing, pinholes, peels, fisheyes, scratches, wrinkling, sags and runs. These paint-related damages are sometimes significant and pose an impact on the aircraft structures, especially the fuselage if not treated appropriately on time. It may lead to corrosion and has an impact on lightning-swept stroke damage. Hence, it is important to detect the paint-related damage continuously and report even the slightest of the issue.

In this case the images of the aircraft parts which are external to aircraft body and have paint related damages are captured and labelled with ‘Paint—Damage’ along with the part type and type of damage as—poor adhesion, blushing, pinholes, peels, fisheyes, scratches, wrinkling, sags and runs. Similarly, the normal part images are also captured and labeled with ‘Paint—Normal’ along with the part type and type of damage as “Not Applicable”.

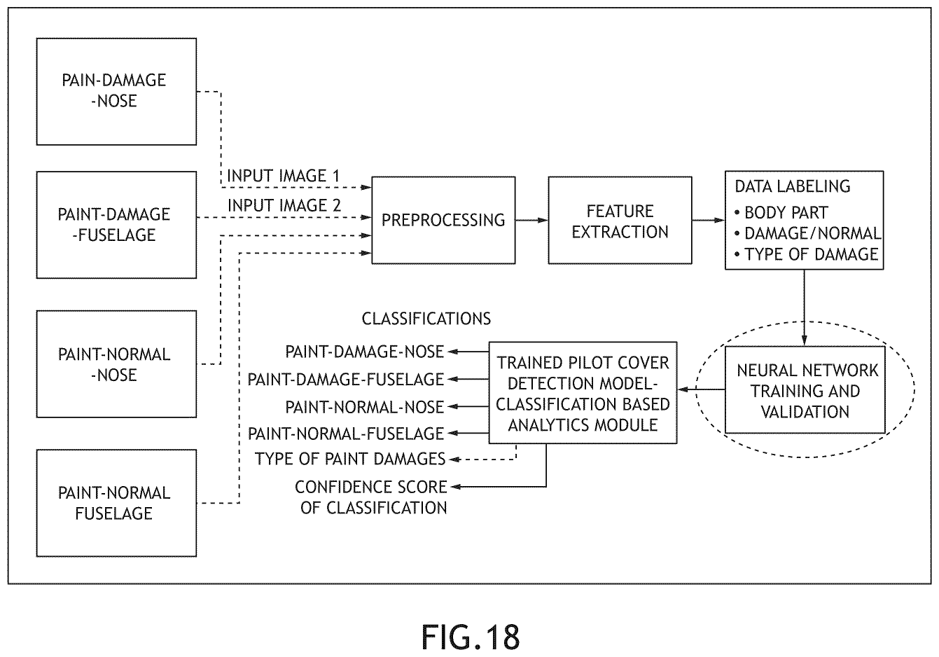

The numerous captured images of the different segments of the aircraft with paint-related damage are captured and labeled. These labeled images are applied to the machine learning models for training as shown in FIG. 18. Once trained the machine learning models can detect the component and its condition for paint like—Paint damage on the wing, pinhole on the fuselage, fisheyes on the fuselage, etc. The real captured images are then supplemented by synthetic data to achieve better accuracy for the detection of paint-related damages of different parts visible at the external surface of the aircraft. Once the required accuracy is achieved for the detection, the trained model is deployed in the field for the identification of paint-related damages on the aircraft's external surfaces. In a few cases, the paints are deliberately damaged and peeled off from the aircraft's external surfaces to capture the images and train the models.

### Example 7

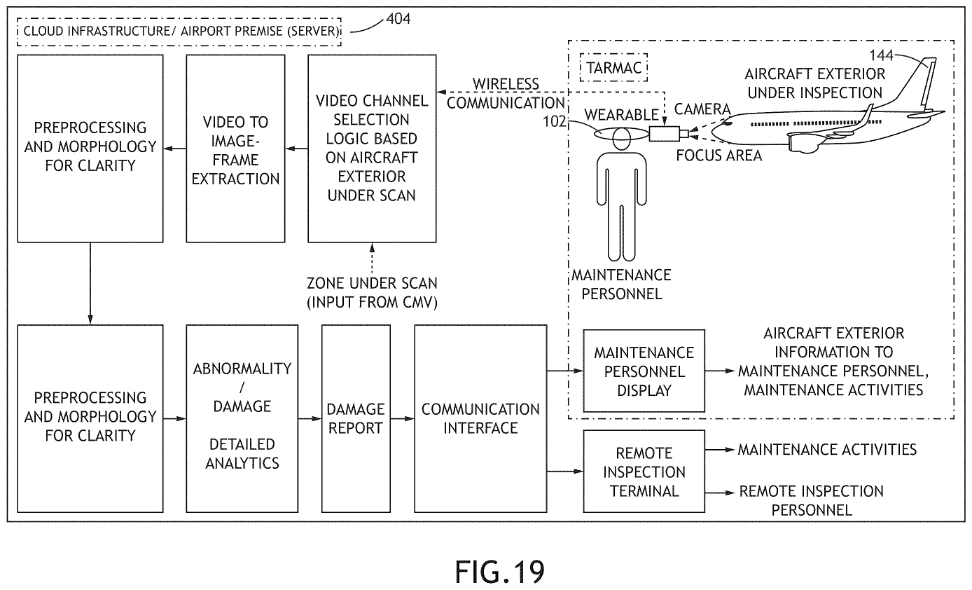

Real-time deployment of Trained Analytics Modules. In embodiments, the trained analytics modules are hosted on the Cloud system which comprises high-performance computing capability for performing the analysis of the photos and videos of the item/exterior under inspection and classification of cracks, dents in the body, any leakage, wear, and tear, FODs, etc. The analytics module is a distributed application hosted on wearable, cloud, and remote maintenance terminals. A high-level block diagram of field camera deployment, segregating videos from the camera, conversion to images and videos, and processing of the images for real-time inspection of the exterior of the aircraft body is shown in FIG. 19

In this setup, the cameras are mounted on the wearable of the maintenance personnel. The maintenance personnel focus the camera on the exterior of the aircraft and transmits the video captured in real time to the Cloud system. The Cloud comprises logic to perform the complete scan of the exterior of the aircraft and based on that generates “zone under scan” and “component under scan” input. This input helps video stream selection logic to select only the stream for which zone and component is under scan. The rest of the video stream input is ignored, and the selected video stream is sent for preprocessing and video to image frame extraction logic.

Once the obtained images are preprocessed, the obtained images are checked for their clarity for analytics. If the required clarity is not achieved the cloud-generated information for controlling the illumination and focus of the camera until the required clarity is achieved. The information is shared with maintenance personnel to generate voice commands for switching on/off or controlling the luminosity of the LEDs to generate sufficient illumination required for inspection.

The preprocessing of the images also helps with fixing the color, monochrome, and size properties of the images for analytics. Once the images are obtained for analytics after preprocessing, they are applied to the analytics block where it is passed through the pre-trained models to detect damage and problems.

The models provide information related to the health status of the component that includes, but is not limited to, damage, normal, dent, painting issues, and placement of the pitot cover, which are sent to the detailed analytics module. The detailed analytics module provides information such as the location of the problem, component, and zone to the damage report generator.

The damage report generator generates the maintenance recommendation, decides if immediate attention is needed and information alarm/alert system to inform the maintenance crew. The damage reports also let the stakeholders decide if immediate action is required or if the maintenance can be postponed. The functionality of the video captured from the camera is communicated through Multiplexed wireless video and data transmissions using time division multiplexed transmission of analog video over a single radio frequency (RF) frequency modulated (FM) video channel from wearable to cloud.

Once the video stream reaches the cloud, it is preprocessed for extracting the image frames. Then the extracted image frames are further processed to enhance the image quality. Also, the segmentation is performed on the images. The output from segmentation is then passed to feature extraction blocks like pooling and activation to extract the features to reduce the computation needs for analytics and focus on the component and zone under inspection.

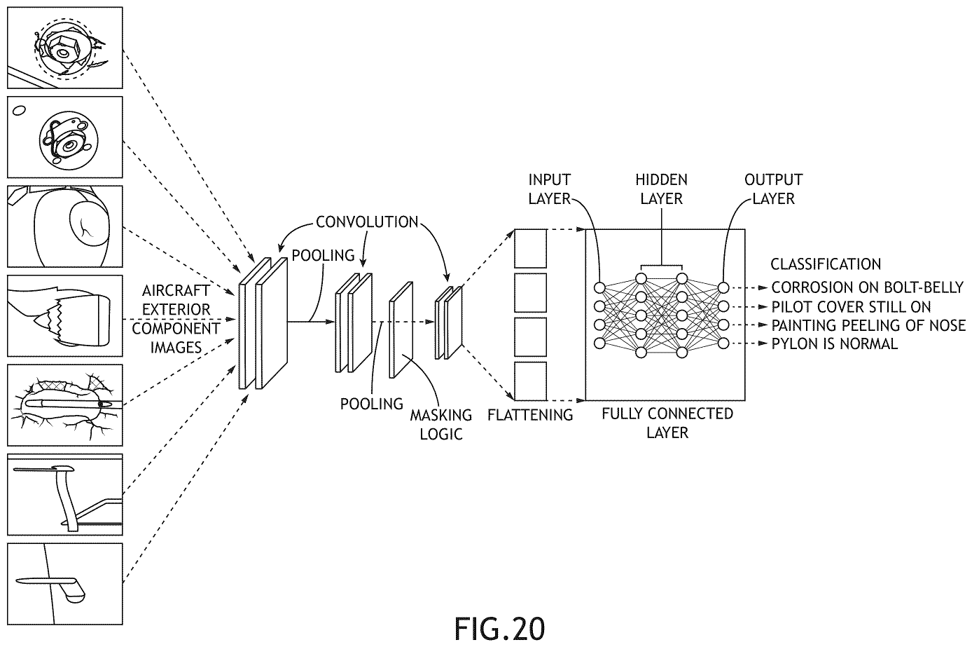

The extracted features are applied to the trained analytics module which helps in detecting the presence of the probe cover. It applies unique algorithms in terms of masking and bounding boxes and performs analytics using workflow as shown in FIG. 20.

The analytics module is equipped with algorithms for edge detection. This enables the analytics module to check the bends, curves, and other aspects of the edge of the component to find its normal structure and any deviation from it.

These methods and systems can also be used for following different inspections of aircraft exteriors. Some of the typical inspections that can be performed include, but are not limited to, FODS (Foreign Object Damages), bird strikes, engine fan blade misalignments, engine fan cowl misalignment, wearing and tearing, lightning strikes damages, oil leakages, loosening screw or body parts, FOD on pitot, AOA, TAT, Static Port, and other sensors, cracks on the fuselage and other body parts, holes on the fuselage and other body parts, defective/fused external lights, removal of chocks before aircraft starts taxing, deicing boot damage inspection, windshield glass cracks, and window glass cracks.

Novel aspects of the system 100 include, but are not limited to, a semi-automatic supplementing system for in field inspection of aircraft exterior, an augmented system to identify the damages observed in the recording replay of images and videos through textual labelling, an augmented system to highlight the damages observed in the images and videos of system/surface under inspection, an automated voice controller checklist for generating record of the inspection, a facility of load older history of the records and compare with current defects and damages, a prognostic of damages/defects for proactive replacement based on historic data and current data, a method for augmenting the display for highlighting the damages to the component/surface for effective identification of damage by maintenance engineer, a hands free system with machine learning based voice system for identification and execution of command provided by maintenance engineer, a distributed system and application running on various devices like wearable strap 102, handheld device or tab, and a cloud computing infrastructure (e.g., server 140) for data gathering and processing for augmented reality based in field inspection of aircraft exteriors.

Novel aspects of the system 100 may include, but are not limited to, image and video processing and analytics algorithms with self and real time learning capabilities running on Cloud infrastructure and supporting multiple in field maintenance engineers to perform detailed analysis of damages using augment reality, voice command operated Eye Lens/Display for maintenance operator to see the captured images/videos of component/surfaces under inspection for an enlarged view and better visibility, zoom in and zoom out feature using voice command, augment menu on the eye lens/display for damage details and maintenance recommendations, a maintenance record/logbook that is semi-automatic and that can be easily accessible to regulatory agencies, and an ability of the system to enable system support maintenance persons in taking decision quickly due to previously available data and analytic modules exist in the system 100 which guide maintenance person if fault or defect is major/minor.

Novel aspects of the system 100 may include, but are not limited to, a 3D inspection of objects to inspect dimensional measurements and metrology, wherein the 3D inspection is used to leverage different techniques to capture depth information, including stereo vision, time-of-flight (ToF), structured light profile scanning, 3D cameras that help in generating point cloud or depth map that represents the three-dimensional structure of the object under check, thermal cameras for inspection and analysis of thermal properties on composites, monitoring of heat patterns, identification of hotspots for aircraft exterior damage detection like tires, wheels, and brakes, camera modes that change between 2D, 3D and Thermal using voice command, a distribution of data between strap storage and cloud infrastructure (e.g., server 140) using in memory data grids and stream tuples for speed and scalable operation, an option to replay the historically stored images and videos using voice-based incident search for comparative study, a software configurable camera focus based on the aircraft structure and airport need, a machine learning and deep learning-based method for detection and classification of aircraft exterior damages, and methods for the use of camera and vision analytics techniques to detect aircraft exterior damages and defects.

Novel aspects of the system 100 include, but are not limited to, methods for using neural network based deep learning technology for scanning different segments of aircraft and detecting damage. This segmentation helps in reducing “FALSE POSITIVE” and “TRUE NEGATIVE” alarms in case probes or sensors 104 are not functioning normally (e.g., missing probe cover). The segmentation also helps improve the accuracy for detecting “TRUE POSITIVES” and “FALSE NEGATIVES” hence overall improved reliability.

Novel aspects of system 100 include, but are not limited to, detailed defect analysis and report generation for reporting the severity of damages and maintenance recommendations, storage of aircraft inspection history and utilization of it for proactive maintenance calls, an automated method to classify the defects and damages as acceptable and safe for flight or requiring an immediate fix, an addition of Generative Adversarial Network (GAN)-based synthetic data for generation of additional data for aircraft exterior damages and training of network for improving accuracy, detection of aircraft defects and damages in all weather and visibility conditions by training the neural network for different weather and visibility conditions, memory-based configurable filter parameters for enabling reuse of same algorithm for various models. control of illumination/LED light to generate high-quality feed data for image analytics and an ultraviolet (UV) light source for detection of oil and fluid leakage.

Novel aspects of the system 100 include, but are not limited to, defect detection which is difficult to track by the naked eye and can be detected using camera and vision analytics, a protocol where every phase of checks (e.g., preflight, postflight, and maintenance, repair and overhaul (MRO) checks) is compared against best case so that even minor deviations are caught, damage classification of the defects like types of paint damages, and self-learning AI and/or ML models for improving accuracy and accommodating new type of defects for identification in future. The system 100 may also provide a replay of the images/videos with the observation made by processing unit. This makes the inspection more reliable and helps new operators to learn.

Benefits of the system 100 include, but are not limited to, human effort saving by semi-automation of the inspection process for various types of inspections, providing optimized services and reducing cost, increased reliability of the detection system and automated checklist driven mistake proofing, eliminating periodic replacement of components (e.g., replacement based on their actual health status), reduced chances of error as several hundred and thousands of inspections worldwide are done by machines without compromise on quality of inspection and eliminates mistakes, decreases pre-flight time, decreases chances of error in identifying the issues and flashing to maintenance, works in different weather and visibility conditions and hence eliminates human error, works for different color, size and structure, and that the configuration reduces rework required for different makes of aircraft and its external components. The system 100s is easily configurable through software updates for different aircraft.

Benefits of system 100 include, but are not limited to, improvement of flight safety through detailed detection of defects, flight schedule delay reduction by proactive identification of the defects and damages, improved accuracy and judgment of problem assessment and maintenance recommendation, reduction in decision time due to use of pre-trained models incorporating the decision factors, reduction in the learning curve of maintenance personnel by augmenting the decision making. The system 100 may easily include new use cases based on future needs by including new models and training them.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system comprising:
a first display;
at least one sensor configured to sense an aspect of an aircraft component, wherein sensing an aspect of the aircraft component generates Aircraft Visual Inspection Assist System (AVIAS) output data; and
at least one processor first communicatively coupled to the first display and the at least one sensor, the at least one processor configured to:
obtain AVIAS output data, the AVIAS output data including a current description of the aircraft component;
obtain a trained artificial intelligence (AI) and/or machine learning (ML) model;
based at least on the AVIAS output data and the trained AI and/or ML model, infer a damage state of the aircraft component; and
display information regarding the damage state of the aircraft component on the first display.

2. The system of claim 1, further comprising a microphone communicatively coupled to the at least one processor and configured to detect a voice of an operator, the at least one processor further configured to;
acquire speech data from the microphone;
extract features from the speech data;
classify extracted features of the speech data to create classified extracted features; and
generate a command based on the classified extracted features, wherein the command includes an operation of a function of the first display or the at least one sensor.

3. The system of claim 1, wherein the first display is a head- or body-worn display.

4. The system of claim 3, further comprising an edge device communicatively coupled to the at least one processor, the edge device comprising a second display.

5. The system of claim 1, further comprising:
a server comprising at least one of the at least one processor and configured to communicate with the first display and the at least one sensor via a wired or wireless interface.

6. The system of claim 1, further comprising at least one illumination source configured to illuminate the aircraft component.

7. The system of claim 6, wherein the at least one illumination source comprises an ultraviolet light source.

8. The system of claim 3, wherein the head- or body-worn display further comprises a microphone and an illumination source.

9. The system of claim 1, wherein one of the at least one sensor comprises a three-dimensional (3D) camera configured to record 3D information about the aircraft component.

10. The system of claim 1, wherein one of the at least one sensor comprises a thermal camera.

11. The system of claim 1, wherein one of the at least one sensor comprises an ultrasonic sensor.

12. The system of claim 1, wherein the damage state comprises corrosion.

13. The system of claim 1, wherein the damage state comprises fluid leakage.

14. The system of claim 1, wherein the trained AI and/or ML model is trained using a supervised learning model.

15. The system of claim 1, wherein the trained AI and/or ML model is trained using a transfer learning technique.

16. The system of claim 2, wherein the system further includes a speech-based AI and/or ML model that has been trained using a supervised technique.

17. The system of claim 2, wherein the system further includes a speech-based AI and/or ML model that has been trained using an unsupervised technique.

18. The system of claim 2, wherein the system further includes a speech-based AI and/or ML model that has been trained using a transfer learning technique.

19. The system of claim 2, wherein the system further includes a speech-based AI and/or ML model that has been trained using a transformer model technique.

20. A method comprising:
speaking an instruction for operating a sensor via a microphone;
operating the sensor and recording sensor data of an aircraft component based on the instruction, generating AVIAS output data;
transmitting the AVIAS output data to a server;
analyzing the AVIAS output data via a trained artificial intelligence (AI) and/or machine learning (ML) model;
inferring a damage state of the aircraft component based on an analysis of the AVIAS output data;
displaying information regarding the damage state of the aircraft component on a first display; and
recording a voice-based log based on displayed information regarding the damage state of the aircraft component via the microphone.
